(19) United States
(12) Patent Application Publication
(10) Pub. No.: US 2026/0326828 A1
(43) Pub. Date: Oct. 22, 2026

(54) FIBER REINFORCED PET FLOOR COVERING

(71) Applicant: Parkland Plastics, Inc., Middlebury, IN (US)

(72) Inventors: Yugang Teng, Shanghai (CN); Ian Nielsen, Cassopolis, MI (US)

(21) Appl. No.: 19/576,788

(22) Filed: Mar. 24, 2026

Related U.S. Application Data
(60) Provisional application No. 63/790,355, filed on Apr. 17, 2025.

(51) Int. Cl. B62D 25/20; B32B 5/02; B32B 5/18; B32B 5/24; B32B 7/12; B32B 27/06; B32B 27/12; B32B 27/36; B62D 21/02; B62D 29/04; E04F 15/10

(52) U.S. Cl. CPC B62D 25/20; B32B 5/02; B32B 5/18; B32B 5/245; B32B 7/12; B32B 27/065; B32B 27/12; B32B 27/36; B62D 21/02; B62D 29/043; E04F 15/102; E04F 15/105; E04F 15/107; B32B 2262/0284; B32B 2262/101; B32B 2307/558; B32B 2307/72; B32B 2307/7376; B32B 2605/00

(57) ABSTRACT

A flooring arrangement includes a foam thermoplastic core having top and bottom surfaces each comprising polyethylene terephthalate and a first density top and bottom thermoplastic layers each having an outer surface and an inner surface and comprising polyethylene terephthalate, wherein the inner surfaces of the top and bottom thermoplastic outer layers are respectively disposed on the top and bottom surfaces of the foam thermoplastic core, and wherein the top and bottom thermoplastic layers each have a second density, and a reinforcing fiber distributed within the top and bottom thermoplastic outer layers thereby structurally reinforcing the same, the reinforcing fiber comprising polyethylene terephthalate and having a third density, wherein the first density is less than both the second density and the third density, and wherein the third density is greater than the second density.

### CROSS-REFERENCE TO PRIOR APPLICATIONS

This application claims priority to U.S. Provisional Patent Application No. 63/790,355, filed Apr. 17, 2025, entitled “FIBER REINFORCED PET FLOOR COVERING,” the entire disclosure of which is incorporated herein by reference.

### FIELD OF THE DISCLOSURE

The present disclosure generally relates to the field of a panel for a flooring arrangement and more particularly to a multi-layered polyethylene terephthalate flooring arrangement for use within recreational vehicles and modular homes.

### SUMMARY OF THE DISCLOSURE

One embodiment as shown and described herein includes a flooring arrangement that includes a foam thermoplastic core having a top surface and a bottom surface and comprising polyethylene terephthalate, wherein the foam thermoplastic core has a first density, a top thermoplastic outer layer having an outer surface and an inner surface and comprising polyethylene terephthalate, wherein the inner surface of the top thermoplastic outer layer is disposed on the top surface of the foam thermoplastic core, a bottom thermoplastic outer layer having an outer surface and an inner surface and comprising polyethylene terephthalate, wherein the inner surface of the bottom thermoplastic outer layer is disposed on the bottom surface of the foam thermoplastic core, and wherein the top thermoplastic layer and the bottom thermoplastic outer layer each have a second density, a reinforcing fiber distributed within the top and bottom thermoplastic outer layers thereby structurally reinforcing the top and bottom thermoplastic outer layers, the reinforcing fiber comprising polyethylene terephthalate and having a third density, wherein the first density is less than both the second density and the third density, and wherein the third density is greater than the second density.

Another embodiment as shown and described herein may further or alternatively include a flooring arrangement that includes a foam thermoplastic core having a top surface and a bottom surface and comprising polyethylene terephthalate, wherein the foam thermoplastic core has a first density, a top thermoplastic outer layer having an outer surface and an inner surface and comprising polyethylene terephthalate, wherein the inner surface of the top thermoplastic outer layer is disposed on the top surface of the foam thermoplastic core, a bottom thermoplastic outer layer having an outer surface and an inner surface and comprising polyethylene terephthalate, wherein the inner surface of the bottom thermoplastic outer layer is disposed on the bottom surface of the foam thermoplastic core, and wherein the top thermoplastic layer and the bottom thermoplastic outer layer each have a second density, and a reinforcing fiber distributed within the top and bottom thermoplastic outer layers thereby structurally reinforcing the top and bottom thermoplastic outer layers, wherein the reinforcing fiber comprises polyethylene terephthalate and has a third density, and wherein the reinforcing fiber is continuous; wherein the first density, the second density and the third density are all different from one another, and wherein the foam thermoplastic core, the top thermoplastic out later, the bottom thermoplastic outer layer, and the reinforcing fiber are configured to be recycled without separation from one another.

Yet another embodiment as shown and described herein may further or alternatively include a flooring arrangement that includes a foam core layer having a first surface and a second surface opposite the first surface and comprising polyethylene terephthalate, the foam core layer having a first density within a range of between about 150 Kg/m³ and about 200 Kg/m³, a pair of non-foaming layers laminated respectively to the first and second surfaces of the foam core layer and comprising polyethylene terephthalate, the pair of non-foaming layers having a second density within a range of between about 120 g/m² and about 200 g/m², and a reinforcing fiber distributed within the top and bottom thermoplastic outer layers thereby structurally reinforcing the top and bottom thermoplastic outer layers, the reinforcing fiber comprising polyethylene terephthalate and having a third density within a range of between about 1600 g/m² and about 2000 g/m².

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a flooring arrangement in the form of a panel;

FIG. 2 is a cross sectional side elevation view of the flooring arrangement; and

FIG. 3 is a cross-sectional side view of an alternative embodiment of the flooring arrangement.

### DETAILED DESCRIPTION

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design, and some schematics may be exaggerated or minimized to show function overview. Therefore, specific structural and functional details disclosed herein are not to be interpreted as limiting, but merely as a representative basis for teaching one skilled in the art to variously employ the present disclosure.

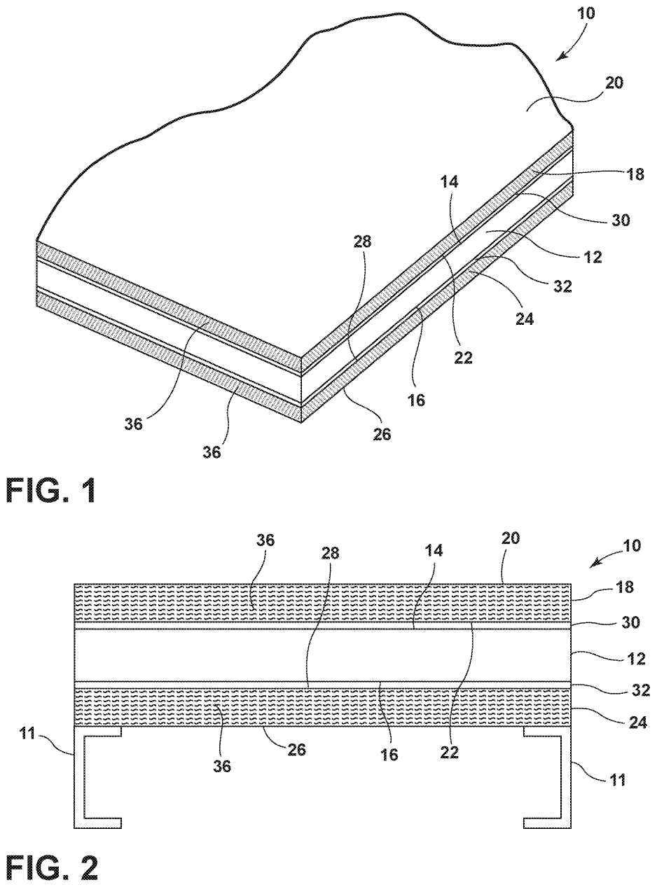

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a panel for a flooring arrangement. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises. a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The reference numeral 10 (FIGS. 1 and 2) generally designates a flooring arrangement in the form of a panel for use within floors and flooring assemblies, and in particular, floor and flooring assemblies within recreational vehicles, manufactured or pre-fabricated homes, marine craft, boats and the like. While the panel as described herein may be utilized as or within a flooring assembly, the panel may also be utilized within wall and ceiling structures, and in particular, wall and ceiling structures within recreational vehicles, manufactured or pre-fabricated homes, general land vehicles, marine vehicles, boats, and the like. The panels as described herein may further be utilized within other arrangements including table tops, counter tops, cabinets, and the like. In certain embodiments, the flooring arrangement 10 is supported directly from structural members or vehicle frame members 11 of the associated vehicle, home and/or watercraft, such as C-shaped frame members, I-beams and/or floor trusses, without the uses of subflooring components and where the flooring arrangement 10 free spans between the structural members 11 without additional supports therebetween. In other embodiments, the upper surface of the flooring arrangement 10 may be provided with an embedded and/or printed outer aesthetic surface such that the upper surface of the flooring arrangement 10 remains exposed and visible after final construction.

In the illustrated example, the flooring arrangement includes a core or core layer 12 having a top or first surface 14 and a bottom or second surface 16, a top outer layer 18 having an outer or first surface 20 and an inner or second surface 22, and a bottom outer layer 24 having an outer or first surface 26 and an inner or second surface 28. In the illustrated example, the core 12 may comprise a thermoplastic material, and in particular may comprise polyethylene terephthalate (PET) or other thermoplastic materials such as polyisocyanurate, and may be provided as a foam, and in particular a closed cell foam. The core 12 preferably has a thickness between the top surface 14 and the bottom surface 16 of within the range of between about 9 mm and about 30 mm, more preferably of between about 16 mm and 30 mm, and most preferably of between about 19 mm and about 25 mm. Each of the top outer layer 18 and the bottom outer layer 24 may preferably have a thickness between the outer surface 20 and the inner surface 22 and between the outer surface 26 and the inner surface 28 of preferably within the range of between about 1 mm and 2 mm, more preferably of between about 1.1 mm and about 1.5 mm, and most preferably of between about 1.2 mm and about 1.4 mm. Each of the top outer layer 18 and the bottom outer layer 24 may comprise a thermoplastic material, and in particular may comprise PET. Each of the top outer layer 18 and the bottom outer layer 24 may also comprise other thermoplastic materials such as polyisocyanurate, and preferably comprise a thermoplastic material such as PET in a non-foam configuration. The top outer layer 18 and the bottom outer layer 24 may be provided with the same or different thicknesses from one another, and further may be provided in a different form from one another.

Preferably, the top outer layer 18 and the bottom outer layer 24 are attached to the core 12 via a thermoforming process, and in particular to a heated roll forming process. In the illustrated example, the bottom outer layer 24 is substantially parallel to the top outer layer 18 across the core 12. Alternatively, the inner surface 22 of the top outer layer 18 is attached to the top surface 14 of the core 12 via a first adhesive layer 30, and the inner surface 28 of the bottom outer layer 24 is attached to the bottom surface 16 of the core 12 via a second adhesive layer 32.

The flooring arrangement 10 may further include a plurality of reinforcement fibers 36 embedded and dispersed within the top outer layer 18 and the bottom outer layer 24. In the illustrated example, the reinforcement fiber 36 is equally dispersed throughout and within each of the outer layers 18, 24. The reinforcement fiber 36 may comprise a PET or another thermoplastic material such as polyisocyanurate. The reinforcement fiber may further be provided as a continuous fiber where the continuous fiber denotes a fiber where the mechanical properties no longer respond to an increase in fiber length. The fibers 36 may be equally dispersed throughout the top outer layer 18 and/or the bottom outer layer 24, the densities of the fibers 36 within or throughout the top outer layer 18 and/or the bottom outer layer 24 may be inconsistent so as to provide further rigidity or greater strength in particular areas.

In the illustrated example, the core 12, the top and bottom outer layers 18, 24 and the reinforcement fibers 36 are provided at various densities. Preferably, the core 12 is provided at a first density, the top and bottom outer layers 18, 24 are each provided at a second density and the reinforcement fiber 36 is provided at a third density, where the first, second and third densities are each different from one another. In one preferred arrangement, the flooring arrangement 10 is configured such that the first density is less than the second density and the third density, and the third density is greater than the second density. Particularly, the density of the core 12 is within a range of between about 100 Kg/m³ and about 300 Kg/m³, more preferably of between about 120 Kg/m³ and about 250 Kg/m³ and most preferably of between about 150 Kg/m³ and about 200 Kg/m³; the second density is preferably within a range of between about 80 g/m² and about 300 g/m², more preferably between about 100 g/m² and about 250 g/m² and most preferably of between about 120 g/m² and about 200 g/m²; and the third density is preferably of within a range of between about 1000 g/m² and about 2500 g/m², more preferably of between about 1200 g/m² and about 2300 g/m² and most preferably of between about 1600 g/m² and 2000 g/m². The various densities provide the overall flooring arrangement 10 with a non-homogeneous distribution of densities throughout the thickness thereof.

As the flooring arrangement 10 comprises the same or similar thermoplastic materials throughout, the flooring arrangement 10 may be recycled directly without separation of the core 12 the top and bottom layers 18, 24 and the reinforcement fibers 36 from one another. As described above, the entirety of the flooring arrangement 10 including the core 12, the top and bottom outer layers 18, 24 and the reinforcing fibers 36 may entirely comprise PET. Benefits of using PET may include but are not limited to good weather resistance, low odor, anti-moth and other insect properties, anti-mildew, anti-flaming, and/or UV resistance.

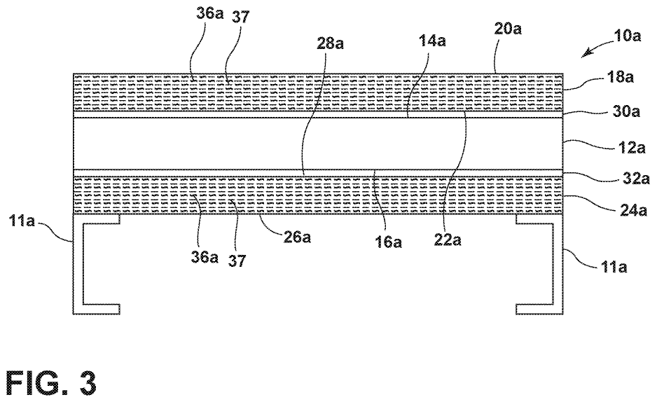

In another embodiment, the flooring arrangement 10a (FIG. 3) may further include a plurality of PET reinforcement fibers 36a and a plurality of fiberglass reinforcement fibers 37 embedded and dispersed within the top layer 18a and the bottom layer 24a. Since the flooring arrangement 10a is similar to the previously described flooring arrangement 10, similar parts appearing in FIGS. 1 and 2 and FIG. 3, respectively are represented by the same, corresponding reference numerals, except for the suffix “a” in the numerals of the latter. In the illustrated example, the PET reinforcement fiber 36a and the fiberglass reinforcement fiber 37 may be equally dispersed throughout and within each of the layers 18a, 24a, as best illustrated within the top layer 18a, or may be layered with one another, as best illustrated within the bottom layer 24a. Similar to as described above, the reinforcement fiber 36a may comprise a PET or another thermoplastic material such as polyisocyanurate. The PET reinforcement fiber 36a may further be provided as a continuous fiber where the continuous fiber denotes a fiber where the mechanical properties no longer correspond to an increase in fiber length. Similarly, the fiberglass reinforcement fiber 37 may be provided as a single continuous strand, or individual pieces that are either patterned, random, form a woven mat, and the like. The fibers 36a, 37 may be equally dispersed throughout the top layer 18a and/or the bottom layer 24a, the densities of the fibers 36a, 37 with or throughout the top layer 18a and/or the bottom layer 24a may be inconsistent so as to provide further rigidity or greater strength in particular areas. Preferably, each of the top and bottom layers 18a, 24a comprise over 50% PET material and less than 50% fiberglass material, more preferably less than 25% fiberglass material, and most preferably less than 5% fiberglass material.

The overall construction as described herein provides further advantages such as increased screw-holding power, impact strength, resistance to permanent deformation subsequent to a load application, and reduce volatile organic compound emissions. In particular, a panel constructed in the manner as described herein provides a screw-holding power tensile force preferably of within a range of between about 700 N and about 1000 N, more preferably between about 800 N and about 900 N, each based on a 4.2 mm thread screw screwed into 15 mm, or a European Standard. BS EN-320 testing standard. Further, the flooring arrangement is configured to provide an impact strength of preferably within a range of between about 147 J and about 299 J, and more preferably between about 220 J and about 299 J without stratified fracture based on a solid steel ball of 10.17 kg weight falling from a freefall weight test height of 1.5-3 m. The flooring arrangement is also configured to provide zero or no deformation subsequent or after a load removal test based on a 1 m², 1000 kg uniform load test

It is to be understood that variations and modifications can be made on the aforementioned structure without departing from the concepts of the present disclosure, and further it is to be understood that such concepts are intended to be covered by the following claims unless these claims by their language expressly state otherwise.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A flooring arrangement, comprising:
a foam thermoplastic core having a top surface and a bottom surface and comprising polyethylene terephthalate, wherein the foam thermoplastic core has a first density;
a top thermoplastic outer layer having an outer surface and an inner surface and comprising polyethylene terephthalate, wherein the inner surface of the top thermoplastic outer layer is disposed on the top surface of the foam thermoplastic core;
a bottom thermoplastic outer layer having an outer surface and an inner surface and comprising polyethylene terephthalate, wherein the inner surface of the bottom thermoplastic outer layer is disposed on the bottom surface of the foam thermoplastic core, and wherein the top thermoplastic layer and the bottom thermoplastic outer layer each have a second density;
a reinforcing fiber distributed within the top and bottom thermoplastic outer layers thereby structurally reinforcing the top and bottom thermoplastic outer layers, the reinforcing fiber comprising polyethylene terephthalate and having a third density;
wherein the first density is less than both the second density and the third density; and
wherein the third density is greater than the second density.

2. The flooring arrangement of claim 1, wherein the reinforcing fiber is continuous.

3. The flooring arrangement of claim 1, further comprising:
a laminated adhesive adhering the top and bottom thermoplastic outer layers to the foam thermoplastic core.

4. The flooring arrangement of claim 1, wherein the foam thermoplastic core, the top thermoplastic outer layer, the bottom thermoplastic outer layer, and the reinforcing fiber are configured to be recycled without being separated from one another.

5. The flooring arrangement of claim 1, wherein the first density is within a range of between about 120 Kg/m³ and about 250 Kg/m³.

6. The flooring arrangement of claim 5, wherein the second density is within a range of between about 100 g/m² and about 250 g/m².

7. The flooring arrangement of claim 6, wherein the third density is within a range of between about 1200 g/m² and about 2300 g/m².

8. The flooring arrangement of claim 1, wherein the foam thermoplastic core has a thickness within a range of between about 16 mm and about 30 mm.

9. The flooring arrangement of claim 8, wherein the top and bottom thermoplastic outer layers each have a thickness within a range of between about 1.1 mm and about 1.5 mm.

10. The flooring arrangement of claim 1, further comprising:
a second reinforcing fiber distributed within at least one of the top and bottom thermoplastic outer layers, wherein the second fiber comprises fiberglass.

11. The flooring arrangement of claim 10, wherein the at least one of the top and bottom layer that comprises the second reinforcement fiber includes less than 50 percent fiberglass by weight.

12. A floor assembly of a recreational vehicle, comprising:
the flooring arrangement of claim 1; and
a pair of vehicle frame members spaced from one another supporting the flooring arrangement, wherein the flooring arrangement free spans between the pair of frame members.

13. The floor assembly of claim 12, wherein the floor arrangement is directly supported on the pair of vehicle frame members.

14. A flooring arrangement, comprising:
a foam thermoplastic core having a top surface and a bottom surface and comprising polyethylene terephthalate, wherein the foam thermoplastic core has a first density;
a top thermoplastic outer layer having an outer surface and an inner surface and comprising polyethylene terephthalate, wherein the inner surface of the top thermoplastic outer layer is disposed on the top surface of the foam thermoplastic core;
a bottom thermoplastic outer layer having an outer surface and an inner surface and comprising polyethylene terephthalate, wherein the inner surface of the bottom thermoplastic outer layer is disposed on the bottom surface of the foam thermoplastic core, and wherein the top thermoplastic layer and the bottom thermoplastic outer layer each have a second density; and
a reinforcing fiber distributed within the top and bottom thermoplastic outer layers thereby structurally reinforcing the top and bottom thermoplastic outer layers, wherein the reinforcing fiber comprises polyethylene terephthalate and has a third density, and wherein the reinforcing fiber is continuous;
wherein the first density, the second density and the third density are all different from one another; and
wherein the foam thermoplastic core, the top thermoplastic out later, the bottom thermoplastic outer layer, and the reinforcing fiber are configured to be recycled without separation from one another.

15. The flooring arrangement of claim 14, wherein the first density is less than both the second density and the third density, and wherein the third density is greater than the second density.

16. The flooring arrangement of claim 14, wherein the flooring arrangement having a 10 mm thickness has a screw-holding power tensile force within a range of between about 700 N and about 1000 N based on a 4 mm thread screw.

17. The flooring arrangement of claim 14, wherein the flooring arrangement has an impact strength of within a range of between about 149 J and about 299 J based on a solid steel ball of 10.17 kg weight falling from a freefall weight test height of 1.5-3 m.

18. The flooring arrangement of claim 14, wherein the flooring arrangement has no permanent deformation after load removal based on a 1 m×1 m 1000 kg uniform load test.

19. The flooring arrangement of claim 14, wherein the flooring arrangement has a volatile organic compound below 0.2 mg/m³.

20. The flooring arrangement of claim 14, wherein the foam thermoplastic core has a thickness within a range of between about 16 mm and about 30 mm.

21. The flooring arrangement of claim 20, wherein the top and bottom thermoplastic outer layers each have a thickness within a range about between about 1.1 mm and about 1.5 mm.

22. The flooring arrangement of claim 14, further comprising:
a second reinforcing fiber distributed within at least one of the top and bottom thermoplastic outer layers, wherein the second fiber comprises fiberglass.

23. A floor assembly of a recreational vehicle, comprising:
the flooring arrangement of claim 14; and
a pair of vehicle frame members spaced from one another supported the flooring arrangement, wherein the flooring arrangement free spans between the pair of frame members.

24. A flooring arrangement, comprising:
a foam core layer having a first surface and a second surface opposite the first surface and comprising polyethylene terephthalate, the foam core layer having a first density within a range of between about 100 kg/m³ and about 300 kg/m³;
a pair of non-foaming layers laminated respectively to the first and second surfaces of the foam core layer and comprising polyethylene terephthalate, the pair of non-foaming layers having a second density within a range of between about 80 g/m² and about 300 g/m²; and
a reinforcing fiber distributed within the top and bottom thermoplastic outer layers thereby structurally reinforcing the top and bottom thermoplastic outer layers, the reinforcing fiber comprising polyethylene terephthalate and having a third density within a range of between about 1000 g/m² and about 2500 g/m².

25. The flooring arrangement of claim 24, wherein the reinforcing fiber is continuous.

26. The flooring arrangement of claim 24, wherein the foam core layer, the pair of non-foaming layers and the reinforcing fiber are configured to be recycled without being separated from one another.

27. The flooring arrangement of claim 24, further comprising:
a second reinforcing fiber distributed within at least one of the top and bottom thermoplastic outer layers, wherein the second fiber comprises fiberglass.

28. A floor assembly of a recreational vehicle, comprising:
the flooring arrangement of claim 24; and
a pair of vehicle frame members spaced from one another supported the flooring arrangement, wherein the flooring arrangement free spans between the pair of frame members.
